(19) United States
(12) Patent Application Publication
(10) Pub. No.: US 2012/0148052 A1
(43) Pub. Date: Jun. 14, 2012

(54) System, Method, and Apparatus for Conveying a Signal to One or More Devices

(76) Inventor: David Adam, Brentwood, CA (US)

(21) Appl. No.: 13/323,752

(22) Filed: Dec. 12, 2011

Related U.S. Application Data
(60) Provisional application No. 61/422,122, filed on Dec. 10, 2010.

(51) Int. Cl. H04B 3/00; H04R 5/00; H01R 13/66; H01R 24/58; H01R 11/11

(52) U.S. Cl. 381/1; 439/669; 439/502; 439/620.01; 381/77

(57) ABSTRACT

A wire system comprising a splitter integrated between two wire portions. The wire system can be used to transmit a signal between a signal source and a first output device connected to the wire portions. At any time, a user can choose to couple one or more additional output devices to the splitter to access the same signal being transmitted to the first output device.

### CROSS-REFERENCE TO RELATED APPLICATIONS

This application claims the benefit of priority to prior filed U.S. Provisional Patent Application No. 61/422,122, filed Dec. 10, 2010, the complete contents of which are hereby incorporated by reference.

### BACKGROUND

1. Field of Invention

The current disclosure relates generally to a wire for conducting signals to a device, and more specifically to a wire having an in-line splitter that can optionally be connected to a second wire to enable additional devices to access the signals.

2. Background

For decades wire systems have been used to connect signal sources such as music players and telephones with output devices such as speakers and headphones. Wiring systems can transmit different types of signals, including audio, video, data, and other signals. Generally, the signal source includes a female socket component that can accept a male plug component on a wire. The wire can be connected directly to an output device, or have another male plug on the other end that can be inserted into a female socket on the output device. The output device can then transmit a signal through the wire to the output device.

Conventional wire systems are easy to use, but they can be limited to conveying signals to a single output device. In cases in which the output device is a pair of headphones and the signal is an audio signal, only a single user can wear the headphones and listen to the audio signal.

Some devices have attempted to solve this problem by including more than one output socket such that multiple devices can be connected to the same signal source at different output sockets and access the same output signal. However, this solution only works for certain devices that include multiple output sockets, and may not be useful for a user who desires to use multiple output devices with any signal source the user desires.

Another solution has been to attach a splitter to the output socket of a signal source, and attach additional wires to the splitter in order to convey the same signal to multiple output devices. Various splitters have included splitters that connect directly to the output socket, and splitters in the shape of a Y or a box located at the end of a wire that is connected to the output socket. However, such splitters are components that are separate from the signal source, wires, and output devices. A splitter that is a separate component can be inconvenient because a user can lose it, find it inconvenient to bring with other equipment, forget to bring it with other equipment, and/or not know when the splitter might be needed in a given situation.

What is needed is a splitter incorporated into the middle of a wire's length such that the wire can transmit a signal to a single output device when desired, while retaining the possibility of at any time connecting an additional output device to the splitter without additional separate components.

### BRIEF DESCRIPTION OF THE DRAWINGS

FIG. 1 is a view of one embodiment of a wiring system comprising a splitter.

FIG. 2 is a view of one embodiment of a wiring system comprising a splitter connected to a signal source, an output device through the wiring system, and a separate output device through the splitter.

FIG. 3 is a view of one embodiment of a wiring system connected directly to an output device.

FIG. 4 is a view of one embodiment of a wiring system connected directly to an output device having two components.

FIG. 5 depicts a cross section of one embodiment of a splitter.

FIG. 6A is a view of one embodiment of a splitter having two jacks.

FIG. 6B is a view of one embodiment of a splitter having a jack positioned orthogonal to the first wire portion and the second wire portion.

FIG. 7A is a top view of an embodiment of a circuit board.

FIG. 7B is a bottom view of an embodiment of a circuit board.

FIG. 7C is a circuit diagram of one embodiment of additional circuitry.

FIG. 7D is a circuit diagram of alternate embodiment of additional circuitry.

FIG. 8 is a view of one embodiment of a splitter having a secondary feature.

FIG. 9 is a view of an alternate embodiment of a wiring system comprising a splitter and a control module.

### DETAILED DESCRIPTION

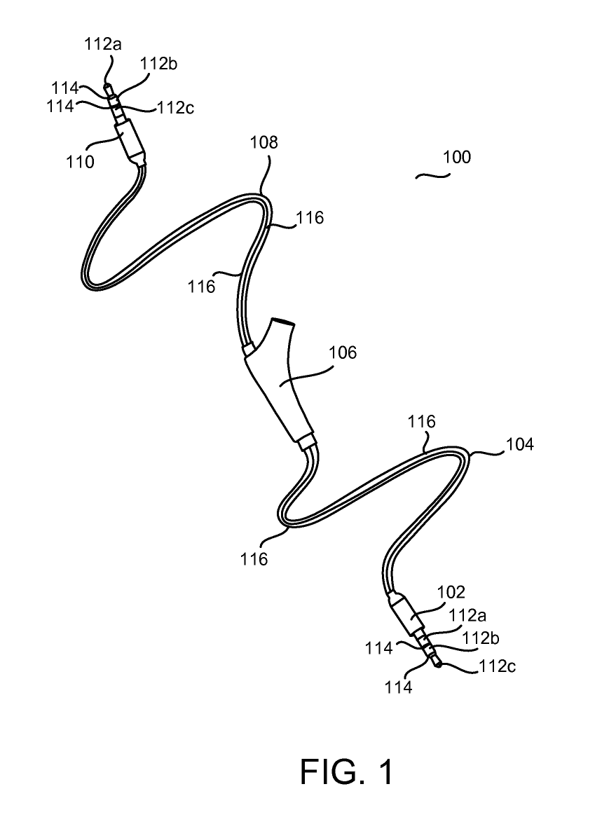

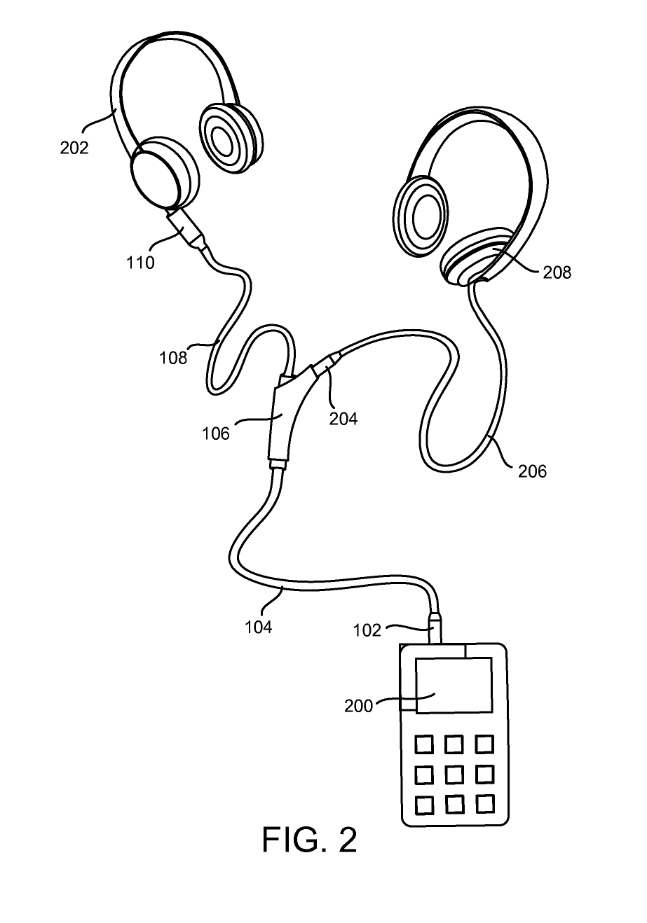

FIG. 1 depicts a wire system 100 comprising a first plug 102, a first wire portion 104, a splitter 106, a second wire portion 108, and a second plug 110 coupled in sequence with one another. The first plug 102 can be a connector configured to be attached to a corresponding connector at a signal source 200 to conduct a signal from the signal source 200, as shown in FIG. 2. The signal source 200 can be any device capable of outputting a signal, such as a music player, telephone, camera, musical instrument, computer, microphone, audio equipment, video equipment, or any other device. The signal can be an audio signal, a video signal, a data signal, a voltage, or any other type of signal. In some embodiments, the first plug 102 can be a male prong or a female socket. The diameter of the male prong or the female socket can be any size, such as 6.35 mm, 3.5 mm, 2.5 mm, or any other size.

In some embodiments, the first plug 102 can comprise one or more conductors 112. Each conductor 112 can be comprised of any material capable of conducting a signal including, but not limited to, copper, gold, steel, or any other known, convenient, desirable, or useful material and/or combination of materials. In some embodiments, the conductors 112 can be separated by insulating rings 114. Each insulating ring 114 can be comprised of any non-conductive material such as rubber, plastic or any other known, useful, convenient and/or desirable non-conductive material or combination of materials. In some embodiments, each conductor 112 can conduct a separate signal or a portion of a signal. By way of a non-limiting example, in the embodiment shown in FIG. 1 the first plug 102 is a TRS connector comprising a tip 112a, a ring 112b, and a sleeve 112c, wherein the tip 112a can conduct a left audio signal, the ring 112b can conduct a right audio signal, and the sleeve 112c can be grounded. By way of an additional non-limiting example, the first plug 102 can be a TRRS connector comprising a tip, a first ring, a second ring, and a sleeve, wherein the tip can conduct a left audio signal, the first ring can conduct a right audio signal, the second ring can conduct a mono audio signal from a microphone, and the sleeve can be grounded. In still other embodiments, the first plug 102 can be a TS connector, an XLR connector, a RCA connector, a RF connector, or any other type of connector.

The second plug 110 can be substantially similar to the first plug 102. The second plug 110 can be a connector configured to be attached to a corresponding connector at an output device 202 to conduct a signal to the output device 202, as shown in FIG. 2. The output device 202 can be any device capable of receiving a signal, such as a speaker, pair of headphones, amplifier, telephone, computer, instrument, audio equipment, video equipment, or any other device. The signal can be an audio signal, a video signal, a data signal, a voltage, or any other type of signal. In some embodiments, the second plug 110 can be a male prong or a female socket. The diameter of the male prong or the female socket can be any size, such as 6.35 mm, 3.5 mm, 2.5 mm, or any other size.

In some embodiments, the second plug 110 can comprise one or more conductors 112. Each conductor 112 can be comprised of any material capable of conducting a signal including, but not limited to, copper, gold, steel, or any other known, convenient, desirable, or useful material and/or combination of materials. In some embodiments, the conductors 112 can be separated by insulating rings 114. Each insulating ring 114 can be comprised of any non-conductive material such as rubber, plastic or any other known, useful, convenient and/or desirable non-conductive material or combination of materials. In some embodiments, each conductor 112 can conduct a separate signal or a portion of a signal. By way of a non-limiting example, in the embodiment shown in FIG. 1 the second plug 110 is a TRS connector comprising a tip 112a, a ring 112b, and a sleeve 112c, wherein the tip 112a can conduct a left audio signal, the ring 112b can conduct a right audio signal, and the sleeve 112c can be grounded. By way of an additional non-limiting example, the second plug 110 can be a TRRS connector comprising a tip, a first ring, a second ring, and a sleeve, wherein the tip can conduct a left audio signal, the first ring can conduct a right audio signal, the second ring can conduct a mono audio signal from a microphone, and the sleeve can be grounded. In still other embodiments, the second plug 110 can be a TS connector, an XLR connector, a RCA connector, a RF connector, or any other type of connector. In some embodiments, the second plug 110 can be the same type of connector as the first plug 102. In alternate embodiments, the second plug 110 can be a different type of connector than the first plug 102.

The first wire portion 104 can comprise one or more wires 116. Each wire 112 can be comprised of any material capable of conducting a signal including, but not limited to, copper, gold, or any other known, convenient, desirable, or useful material and/or combination of materials. Each wire 116 can be any gauge suitable for the particular application and/or the type of signal to be conducted through the wire 116. In some embodiments, each wire 116 can conduct a specific signal or portion of a signal. By way of a non-limiting example, one wire 116 can conduct a left audio signal and a different wire 116 can conduct a right audio signal. The first wire portion 104 can comprise a different number of wires 116 depending on the desired application. By way of a non-limiting example, one embodiment of a first wire portion 104 can comprise two wires 116 for two audio signals, while a different embodiment of a first wire portion 104 can comprise two wires 116 for two audio signals, a third wire 116 for an audio signal from a microphone, and a fourth wire 116 for data signals such as play/pause commands. The first wire portion 104 can have any length desired for a particular application. In some embodiments, the wires 116 can be insulated by a non-conducting material such as rubber, plastic or any other known, useful, convenient and/or desirable non-conductive material or combination of materials. In alternate embodiments, the non-conducting material can be absent. One end of the first wire portion 104 can be coupled with the first plug 102, and the other end of the first wire portion 104 can be coupled with the splitter 106.

The second wire portion 108 can comprise one or more wires 116. Each wire 116 can be comprised of any material capable of conducting a signal including, but not limited to, copper, gold, or any other known, convenient, desirable, or useful material and/or combination of materials. Each wire 116 can be any gauge suitable for the particular application and the type of signal to be conducted through the wire 116. In some embodiments, each wire 116 can conduct a specific signal or portion of a signal. By way of a non-limiting example, one wire 116 can conduct a left audio signal and a different wire 116 can conduct a right audio signal. The second wire portion 108 can comprise a different number of wires 116 depending on the desired application. By way of a non-limiting example, one embodiment of a second wire portion 108 can comprise two wires 116 for two audio signals, while a different embodiment of a second wire portion 108 can comprise two wires 116 for two audio signals, a third wire 116 for an audio signal from a microphone, and a fourth wire 116 for data signals such as play/pause commands. The second wire portion 108 can have any length desired for a particular application. In some embodiments the second wire portion 108 can be longer than the first wire portion 104. In other embodiments the second wire portion 108 can be the same length as the first wire portion 104. In still other embodiments the second wire portion 108 can be shorter than the first wire portion 104. In some embodiments, the wires 116 can be insulated by a non-conducting material such as rubber, plastic or any other known, useful, convenient and/or desirable non-conductive material or combination of materials. In alternate embodiments, the non-conducting material can be absent.

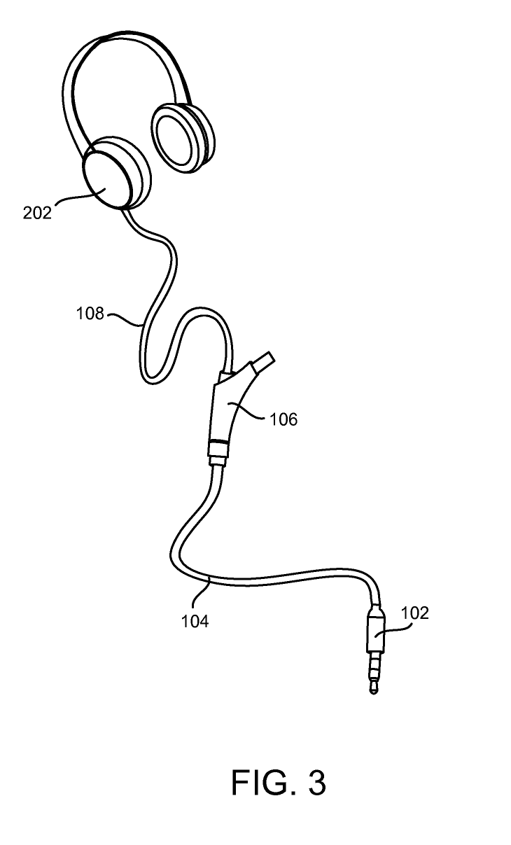

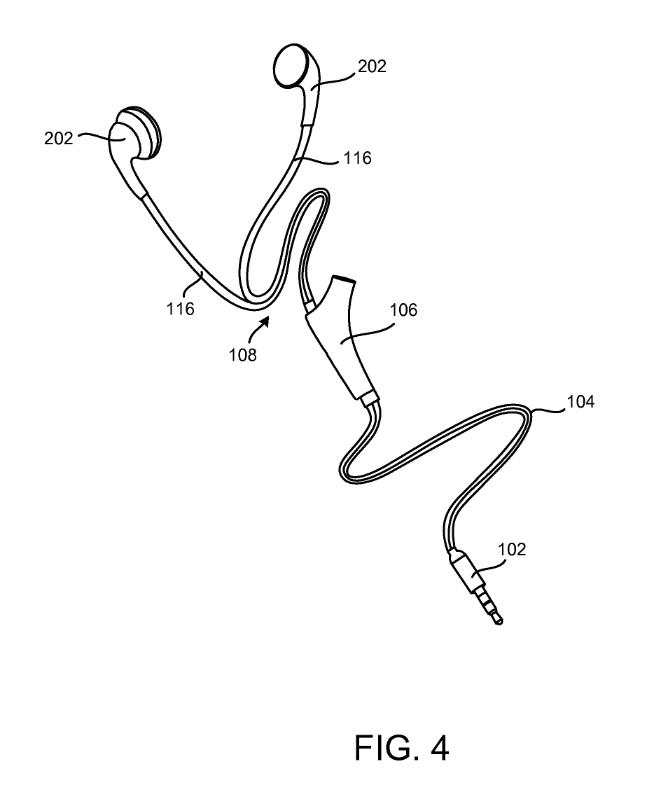

In some embodiments, one end of the second wire portion 108 can be coupled with the second plug 110, and the other end of the second wire portion 108 can be coupled with the splitter 106, as shown by FIG. 1. In alternate embodiments, one end of the second wire portion 108 can be coupled with an output device 202 directly, and the other end of the second wire portion 108 can be coupled with the splitter 106, as shown by FIG. 3. In some embodiments, each wire 116 of the second wire portion 108 can be separated such that each wire 116 can be separately coupled with an individual component of the output device 202 that is designed to receive the signal carried by that wire 116, as shown by FIG. 4.

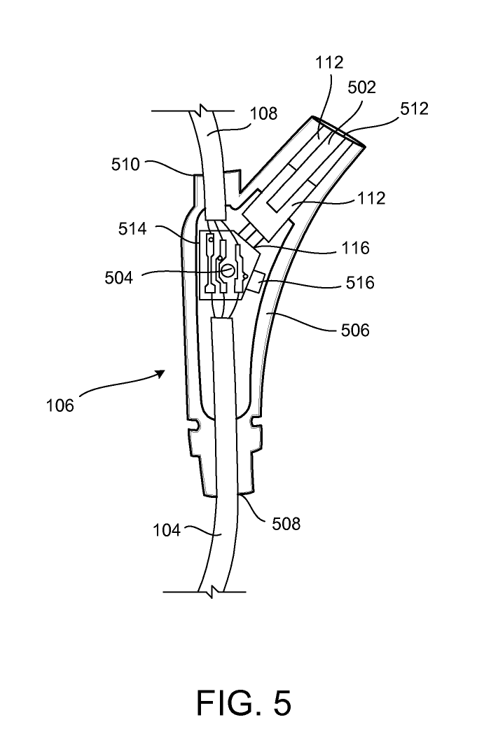

FIG. 5 depicts a cross section of the splitter 106. The splitter 106 can comprise one or more jacks 502, one or more connection points 504, and a housing 506. Each jack 502 can be a connector designed to interact with a corresponding connector to conduct a signal to an additional output device. By way of a non-limiting example, FIG. 2 depicts an additional output device 208 connected to the splitter through a wire 206 and a corresponding connector 204 inserted into the splitter 106 at the jack 502, such that the additional output device 208 can access the same signal from the signal source 200 as the output device 202. In some embodiments, the jack 502 can comprise one or more conductors 112. Each conductor 112 can be comprised of any material capable of conducting a signal including, but not limited to, copper, gold, steel, or any other known, convenient, desirable, or useful material and/or combination of materials. In some embodiments, the jack 502 can be a female socket designed to accept a male prong. The female socket can have the same number of conductors 112 as a male prong, such that each conductor 112 on the male prong can transmit a specific signal or portion of a signal to a specific corresponding conductor 112 in the female socket. The jack 502 can have the number of conductors 112 necessary for a particular application. By way of a non-limiting example, in some embodiments the jack 502 can have multiple conductors 112 such that the jack 502 can conduct multiple signals, such as a left audio signal, a right audio signal, and/or a data signal. By way of another non-limiting example, a jack 502 can have a single conductor 112 designed to conduct a mono audio signal from a microphone. In other embodiments, the jack 502 can be similar to the first plug 102 and/or the second plug 110. In still other embodiments, the jack 502 can have any known or convenient geometry and use any connection mechanism capable of conducting a signal.

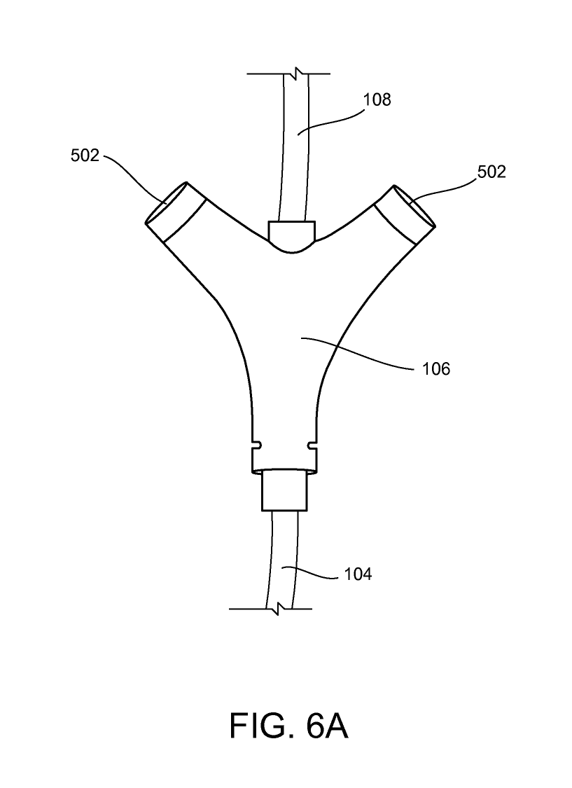

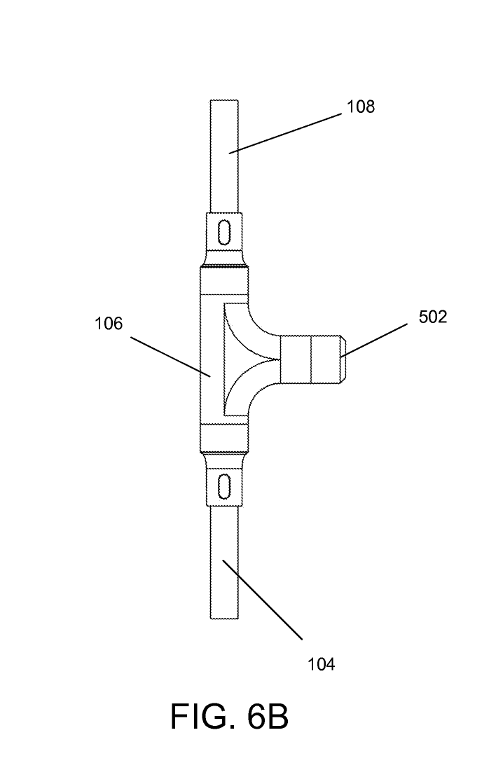

In the embodiments shown in FIGS. 1-5, the splitter 106 comprises one jack 502. In alternate embodiments, the splitter 106 can comprise a plurality of jacks 502, as shown in FIG. 6A. Each jack 502 can be located at any location on the splitter 106 and can be oriented in any direction. In the embodiments shown in FIGS. 1-5, the jack 502 is on a side of the splitter 106 not in line with the first wire portion 104 and the second wire portion 108, and the jack 502 is angled at an obtuse angle with the first wire portion 104 and at an acute angle with the second wire portion 108. In alternate embodiments, the jack 502 can be orthogonal with the first wire portion 104 and the second wire portion 108, as shown in FIG. 6B. In still other embodiments, the jack 502 can be parallel with the first wire portion 104 and/or second wire portion 108, or can have any other position and orientation.

The connection points 504 can be conduction mechanisms through which a signal from one wire or component can be transmitted to one or more other wires or components. Each connection point 504 can be a path, joint, or area comprising one or more conductive materials such as gold, copper, silver, solder, metal, metal alloy, or any other material capable of conducting a signal.

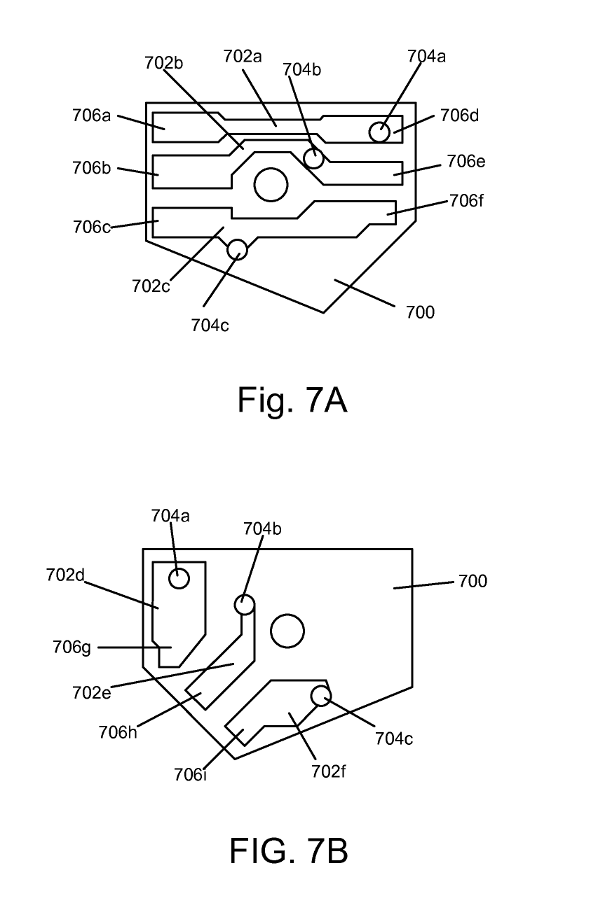

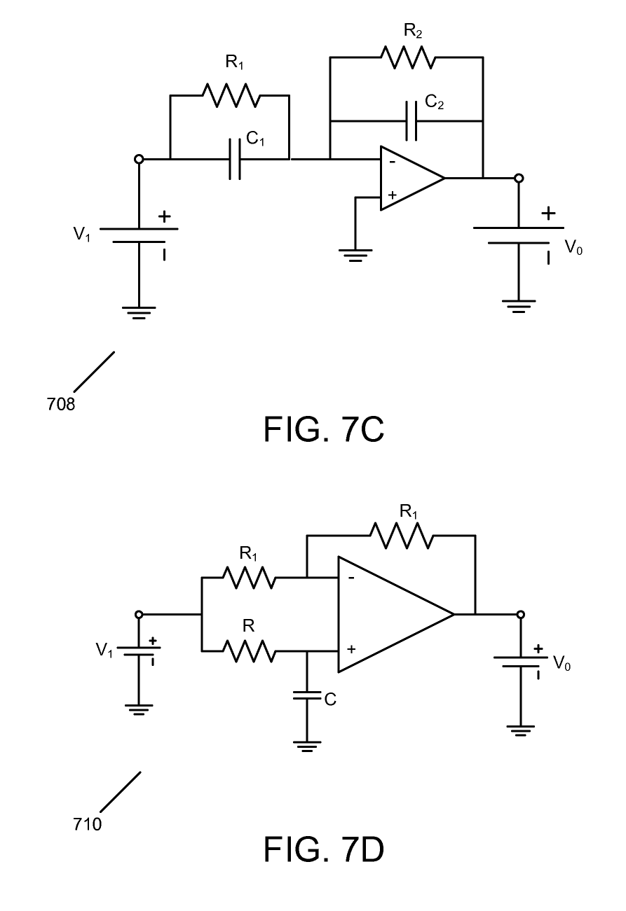

FIG. 7A depicts a top view of one embodiment of connection points 504 on a circuit board 700. FIG. 7B depicts a bottom view of the same embodiment of a circuit board 700. In some embodiments, the connection points 504 can be conduction patterns 702, vias 704, and/or other conduction mechanisms located on the circuit board 700. The conduction patterns 702 can conduct a signal to any point on the same conduction pattern 702. The vias 704 can conduct a signal from one conduction pattern 702 to a different conduction pattern 702 on the other side of the circuit board 700.

In alternate embodiments, the connection points 504 can be connected to additional circuitry 514 to enable volume amplification, volume control, volume limiting, bass boost, switching the jack on or off, or any other desired additional functions. In some embodiments, the additional circuitry 514 can be a general amplifier 708, as shown in FIG. 7C. In alternate embodiments, the additional circuitry 514 can be an all pass amplifier 710, as shown in FIG. 7D. In some embodiments, the additional circuitry 514 can be powered by a battery 516 or any other power source. In some embodiments, the additional circuitry 514 and battery 516 can be located on a circuit board, such as the circuit board 700 shown in FIG. 7A and FIG. 7B.

The housing 506 can be an enclosure that surrounds the connection points 504 and the jacks 502. The housing 506 can have a first opening 508, a second opening 510, and an additional opening 512 for each jack 502. The housing 506 can have any desired shape and size. In the embodiment shown in FIG. 5, the housing 506 is shaped to fit tightly around the first wire portion 104, the second wire portion, the connection points 504, and the jack 502. In alternate embodiments, the housing 506 can have a geometric shape such as a ball or box, have a shape resembling a product, have a shape resembling a cartoon character, or have any other desired shape. In some embodiments, the first opening 508 and the second opening 510 can be in line with each other on opposing ends of the splitter 106. In alternate embodiments, the first opening 508 and the second opening 510 can be located anywhere on the housing.

The first wire portion 104 can enter the housing 506 through the first opening 508. The second wire portion 108 can enter the housing 506 through the second opening 510. The first wire portion 104 and the second wire portion 108 can meet inside the housing 506 and be electrically coupled with each other at the connection points 504. Each jack 502 can meet with and be electrically coupled with the first wire portion 104 and the second wire portion 108 at the connection points 504. In some embodiments, each jack 502 can be directly coupled with the connection points 504. In alternate embodiments, each jack 502 can be coupled with the connection points 504 with one or more wires 116.

The connection points 504 can be configured such that the signal from the first wire portion 104 can be conducted through the connection points 504 to both the second wire portion 104 and the jack 502, such that when a corresponding connector 204 is inserted into the jack 502, the signal can be conducted through the corresponding connector 204 to the additional output device 208, as shown in FIG. 2. In some embodiments, the signals can be conducted through the connection points 504 such that they are transmitted, split, and/or combined in any direction. By way a non-limiting example, a signal from the first wire portion 104 can be conducted to the second wire portion 108 and the jack 502. By way of another non-limiting example, a signal from the second wire portion 108 can be conducted to the first wire portion 104 and the jack 502. By way of still another non-limiting example, a signal from the second wire portion 108 can be combined with a signal from the jack 502 and both signals can be conducted to the first wire portion 104.

By way of a non-limiting example, in the circuit board 700 shown in FIGS. 7A and 7B, the wires 116 of the first wire portion 104 can be coupled with the conduction patterns 702 at connection points 706a, 706b, and 706c. The wires 116 of the second wire portion 108 can be coupled with the conduction patterns 702 at points 706d, 706e, and 706f. A jack 502 can be coupled with the conduction patterns 702 at points 706g, 706h, and 706i directly or with wires 116. In operation, in this example a right audio signal can be conducted from the first wire portion 104 at point 706a through the conduction pattern 702a to the second wire portion 108 at point 706d, and through the conduction pattern 702a, via 704a, and the conduction pattern 702d to the jack 502 at point 706g. A ground signal can be conducted from the first wire portion 104 at point 706b through the conduction pattern 702b to the second wire portion 108 at point 706e, and through the conduction pattern 702b, via 704b, and the conduction pattern 702e to the jack 502 at point 706h. A left signal can be conducted from the first wire portion 104 at point 706c through the conduction pattern 702c to the second wire portion 108 at point 706f, and through the conduction pattern 702c, via 704c, and the conduction pattern 702f to the jack 502 at point 706i. When no corresponding connector 202 is inserted into the jack 502, the signals can be conducted from the first wire portion 104 to the second wire portion 108. When a corresponding connector 202 is inserted into the jack 502, the signals can be conducted from the first wire portion 104 to the second wire portion 108 and the corresponding connector 202 through the jack 502.

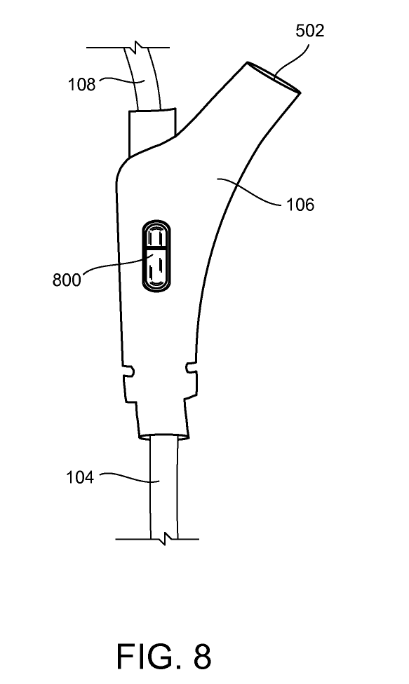

FIG. 8 depicts an alternate embodiment in which the splitter 106 further comprises one or more secondary features 800. Secondary features 800 can include a microphone, a display screen, an amplifier, controls, and/or any other desired feature. Controls can include volume controls, an on/off switch, play/pause buttons, a volume limiter, a camera shutter control, or any other control for any type of feature. Controls can be buttons, knobs, switches, dials, or any other mechanism. In some embodiments, the secondary features 800 can alter the signals conducted from the first wire segment 104 to the second wire segment 108 and the jack 502 through the connection points 504. By way of a non-limiting example, in some embodiments a secondary feature 800 can be a volume control that changes an audio signal to be louder or quieter. In alternate embodiments, the secondary features 800 can create and transmit a signal to the signal source 200. By way of a non-limiting example, in some embodiments a secondary feature 800 can be a play/pause button that can send a command to the signal source 200 such that the signal source 200 can play or pause transmission of an audio signal.

In some embodiments, the secondary features 800 can operate through additional circuitry, electronic components, wires, or other components located within the housing 506. By way of a non-limiting example, a secondary feature 800 comprising an amplifier can operate through the general amplifier circuit shown in FIG. 7C. By way of a non-limiting example, a secondary feature 800 comprising an amplifier can operate through the all pass amplifier circuit shown in FIG. 7D. In some embodiments, the secondary features 800 can be powered by a power source, such as the batteries 516 shown in FIG. 5, solar power, kinetic energy, or any other power source.

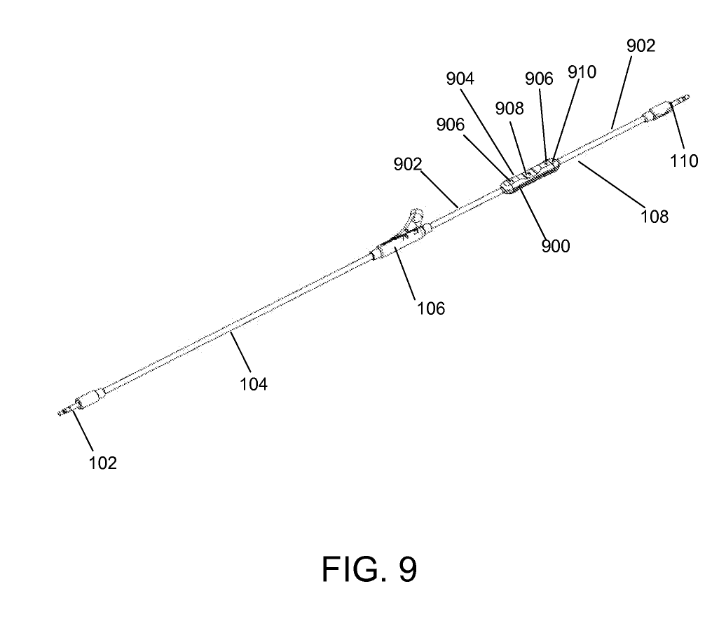

FIG. 9 depicts an alternate embodiment of a wiring system 100 that further comprises a control module 900. The control module 900 can be integrated into the first wire portion 104 or the second wire portion 108. In some embodiments, the first wire portion 104 or the second wire portion 108 can be split into two segments 902, with the control module 900 electrically coupled in between the two segments 902, such that a signal conducted through one segment 902 can be conducted through the control module to the other segment 902.

The control module 900 can comprise one or more secondary features 904. Secondary features 904 can include a microphone, a display screen, an amplifier, controls, and/or any other desired feature. Controls can include volume controls, an on/off switch, play/pause buttons, a volume limiter, a camera shutter control, or any other control for any type of feature. Controls can be buttons, knobs, switches, dials, or any other mechanism. By way of a non-limiting example, the embodiment shown in FIG. 9 comprises volume buttons 906, a play/pause button 908, and a microphone 910. In some embodiments, the secondary features 904 can alter the signals conducted from one segment to the other segment through the control module. By way of a non-limiting example, in some embodiments a secondary feature 904 can be a volume control that changes an audio signal to be louder or quieter. In alternate embodiments, the secondary features 904 can create and transmit a signal to the signal source 200. By way of a non-limiting example, in some embodiments a secondary feature 904 can be a play/pause button that can send a command to the signal source 200 such that the signal source 200 can play or pause transmission of an audio signal.

In some embodiments, the secondary features 904 can operate through circuitry, electronic components, wires, or other components located within the control module 900. By way of a non-limiting example, a secondary feature 900 comprising an amplifier can operate through the general amplifier circuit shown in FIG. 7C. By way of a non-limiting example, a secondary feature 800 comprising an amplifier can operate through the all pass amplifier circuit shown in FIG. 7D. In some embodiments, the secondary features 904 can be powered by a power source, such as the batteries 516 shown in FIG. 5, solar power, kinetic energy, or any other power source.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A wire system, comprising:
a first wire portion;
a second wire portion; and
a splitter comprising one or more jacks and one or more connection points;
wherein said first wire portion, said second wire portion, and said one or more jacks are each electrically coupled with said one or more connection points inside said splitter, and
said first wire portion is in line with said second wire portion.

2. The wire system of claim 1, further comprising:
a first plug electrically coupled with said first wire portion; and
a second plug electrically coupled with said second wire portion.

3. The wire system of claim 1, further comprising:
a first plug electrically coupled with said first wire portion; and
an output device electrically coupled with said second wire portion.

4. The wire system of claim 1, wherein said first wire portion and said second wire portion each comprise of a plurality of individual wires configured to conduct a different signal.

5. The wire system of claim 1, wherein said splitter further comprises a power switch.

6. The wire system of claim 1, wherein said splitter further comprises a volume amplifier.

7. The wire system of claim 1, wherein said splitter further comprises a volume control.

8. The wire system of claim 1, wherein said splitter further comprises a power source.

9. The wire system of claim 1, wherein said first wire portion comprises a first segment, a control module, and a second segment electrically coupled in sequence.

10. The wire system of claim 1, wherein said second wire portion comprises a first segment, a control module, and a second segment electrically coupled in sequence.

11. A wire system, comprising:
a first plug, a first wire section, a splitter, a second wire section, and a second plug electrically coupled in sequence;
wherein said splitter comprises at least one auxiliary jack configured to accept a third plug.

12. A method of transmitting a signal through a wire system, comprising:
conducting a signal through a first wire portion;
conducting said signal from said first wire portion through a splitter to a second wire portion in line with said first wire portion; and
conducting said signal from said first wire portion through said splitter to a third wire portion when said third wire portion is selectively electrically coupled with the splitter at a jack.

13. The method of claim 12, wherein said signal is an audio signal.

14. The method of claim 13, wherein said audio signal is a stereo audio signal.

15. The method of claim 13, wherein said audio signal is a mono audio signal.
